(19) United States
(12) Patent Application Publication
(10) Pub. No.: US 2025/0011003 A1
(43) Pub. Date: Jan. 9, 2025

(54) METHOD AND SYSTEM FOR ASSISTING THE PILOTING OF AN AIRCRAFT WITH A HEAD-UP DISPLAY

(71) Applicant: AIRBUS HELICOPTERS, Marignane Cedex (FR)

(72) Inventor: Jean-Pierre BAUDRY, Toulon (FR)

(73) Assignee: AIRBUS HELICOPTERS, Marignane Cedex (FR)

(21) Appl. No.: 18/596,361

(22) Filed: Mar. 5, 2024

(30) Foreign Application Priority Data
Apr. 17, 2023 (FR) 2303688

(51) Int. Cl. B64D 43/00; G09G 3/00

(52) U.S. Cl. CPC B64D 43/00; G09G 3/001; G09G 2354/00; G09G 2380/12

(57) ABSTRACT

A method for assisting the piloting of an aircraft comprising a head-up display and an automatic flight control system that comprises a human-machine selection interface for choosing an operating mode from among several predetermined operating modes comprising a disengaged mode and an engaged mode, the automatic flight control system being configured, in the engaged mode, to control at least one actuator in order to bring a current value of a controlled parameter towards a setpoint value. The method comprises: i) detecting, with a control system, an applied current mode from among the several predetermined operating modes; and ii) controlling and displaying, on the head-up display, a symbol carrying the current value according to a graphic charter specific to the current mode, a first graphic charter applied during the disengaged mode being different from a second graphic charter applied during the engaged mode.

### CROSS-REFERENCE TO RELATED APPLICATIONS

This application claims priority to French patent application No. FR 2303688 filed on Apr. 17, 2023, the disclosure of which is incorporated in its entirety by reference herein.

### TECHNICAL FIELD

The present disclosure relates to a method and device for assisting the piloting of an aircraft with a head-up display.

### BACKGROUND

An aircraft may be provided with various displays for displaying information that is useful for an operator. Furthermore, an aircraft may comprise an automatic flight control system suitable for piloting the aircraft, so that at least one flight parameter is brought towards a setpoint value.

The term “operator” may denote a pilot, a copilot or indeed any person working in a cockpit.

The term “information” may refer to symbols that include, for example, geometric shapes, numbers and letters; these symbols may vary over time and may, in particular, represent physical quantities or objects.

This information includes information considered by a person skilled in the art to be “primary information” and information considered to be “secondary information”. Primary information relates to information for piloting in the short term, or indeed information that is essential for piloting. Secondary information covers all the other information that can be displayed, for example weather data, data for setting a desired course, etc.

In order to present these various items of information to an operator, an aircraft may include one or more displays referred to as “head-down” displays. A head-down display is visible to an operator when this operator looks downwards into the cockpit. A head-down display may, for example, be carried by an instrument panel or a pedestal.

For the record, when the operator looks upwards and out of the aircraft, and therefore in particular towards the environment situated above an instrument panel and a pedestal, a person skilled in the art considers this operator to be in a “head-up” position. Conversely, when the operator is looking at the inside of the aircraft, and in particular at the instrument panel or the pedestal, a person skilled in the art considers this operator to be in a “head-down” position.

A head-down display may, for example, comprise a “screen”. In particular, a multifunction screen may display various pages that can contain various items of information. Therefore, a multifunction screen may display one or more pages containing primary information and/or secondary information. An operator can choose the page to display.

In order to find out what information is shown on such a head-down display, an operator therefore needs to look into the cockpit regularly. However, when the aircraft is close to terrain or an obstacle, for example during a winching or rescue operation, a pilot frequently looks out of the cockpit in order to detect possible danger. Therefore, frequently consulting a head-down display in such a situation increases the pilot's workload, and indeed the risk of an accident.

Documents EP 3 454 016 and EP 3 869 158 disclose head-down displays.

In order to solve this problem, an aircraft may also comprise a head-up display for displaying important information to an operator when this operator is in the head-up position.

For example, a head-up display may comprise a screen of a helmet worn by a pilot, a retinal projection device, a windshield projection means, or a device known as a “head-up display” or HUD. A head-up display may comprise, for example, a system referred to as a “head-mounted display”, a system referred to as a “head-worn display”, a system referred to as a “near-eye display”, or indeed a system referred to as a “helmet-mounted display” when the system is mounted on a helmet, or indeed a system referred to, for example, as a “helmet-mounted sight and display”.

Irrespective of the embodiment of a head-up display, this head-up display may help reduce a pilot's workload by removing the need to consult the head-down displays. The information displayed on the head-up display is superposed on the outside view, from which the pilot takes visual references that are essential for visual piloting of the aircraft. To illustrate this aspect, during a winching operation, a pilot can view the head-up information while observing the overflown scene through a windshield. The pilot then has no need to look into the cockpit.

Moreover, the head-up display can collimate the displayed images to infinity, or at least to a distance much greater than the distance separating the pilot or copilot from the instrument panel. This means that the pilot or copilot does not need to focus his or her eyes in order to switch from the outside view to reading the information displayed on the head-up display. This feature helps limit user fatigue and reduces the time needed to access the displayed information.

The head-up display can also be used to display information superposed on the outside environment. A person skilled in the art refers in this case to conformal information. For example, a symbol may be positioned at the exact location of the predetermined landing point.

A head-up display is therefore advantageous. However, the displayed information must be limited. Indeed, displaying lots of information on the head-up display could ultimately prevent the user from correctly distinguishing the outside environment, that would defeat the purpose of the head-up display. Therefore, the information displayed on a conventional head-up display is generally limited to essential piloting information, and often does not include useful information relating to an automatic flight control system.

Indeed, a pilot may, for example, have an automatic flight control mode engaged for level flight. The pilot can operate the controls of the aircraft in order to change flight level, for example to avoid an obstacle. When the pilot releases the controls, the automatic flight control system becomes active again. The pilot may have forgotten that the automatic flight control system is engaged and may be surprised by the behavior of the aircraft resulting from the reactivation of the automatic flight control.

For example, a head-down display may show an image comprising a speed indicator, a heading rose, a pressure altitude indicator and an artificial horizon. This image may also contain symbols relating to an active automatic flight control system, such as a setpoint speed value, a setpoint heading value and a setpoint altitude value, an index pointing to the setpoint speed on the speed indicator, an index pointing to the setpoint heading on the heading rose, and an index pointing to the setpoint altitude on the pressure altitude indicator.

Conversely, the head-up display only shows an image comprising a speed indicator, a heading scale, a pressure altitude indicator, and a conformal symbol carrying the aircraft's flight direction vector.

According to another aspect, a head-up display may be monochromatic, that limits the possibilities of transmitting information visually. Furthermore, the display area of a head-up display may be limited, generally being circular/elliptical or potato-shaped, unlike a rectangular screen of a head-down display.

The Web page www.code450.com/heads-up-display discloses a monochromatic head-up display. This display shows numerous items of information and, in particular, a panel indicating the activated automatic flight control modes. The field of view is relatively cluttered.

The report titled “Symbologie des collimateurs tête haute (HUD): Etude pré réglementaire pour le SFACT.” dated 2002, that can be viewed on the Web page http://www.headupflight.net/Documents/hudF.pdf, presents a head-up collimator showing various items of information during an approach.

Document FR 3 038 380 describes a display showing, in particular, a slope symbol, a slope scale, constraint symbols and a guidance setpoint based on the slope scale.

These documents are useful but show displays displaying symbols dedicated to setpoints that actually overwhelm an operator's field of view.

The following documents are also known:
“EuroFighter C.16 FLIGHT MANUAL”, 31 Mar. 2005 (2005-03-31), XP055179064; retrieved from the Internet: URL: http://air.felisnox.com/view.php?name=euroa.pdf; and
“FlyRealHUDs Very Brief User's Manual”, 31 Dec. 2012 (2012-12-31), XP093095948; retrieved from the Internet: URL: http://flyrealhuds.com/wp-content/uploads/2020/01/FlyRealHUDs-AirTransport-Users-Manual.pdf.

### SUMMARY

An object of the present disclosure is thus to propose an innovative method for optimizing the workload of an operator of an aircraft, and in particular a pilot's workload.

The present disclosure therefore relates to a method for assisting the piloting of an aircraft comprising a head-up display and an automatic flight control system, the automatic flight control system comprising a human-machine selection interface for choosing one operating mode from several predetermined operating modes comprising a disengaged mode and an engaged mode in order to request the automatic control of at least one parameter, the automatic flight control system being configured, in the engaged mode, to control at least one actuator of the aircraft in order to bring a current value of said parameter towards a setpoint value.

This method comprises the following steps:
detecting, with a control system, an applied current mode from among said several predetermined operating modes; and
controlling the head-up display with the control system and displaying, on the head-up display, a symbol carrying said current value according to a graphic charter specific to the current mode in order to display the current mode, a first graphic charter applied during the disengaged mode being different from a second graphic charter applied during the engaged mode.

This method may be implemented for one or more parameters that can be controlled by the automatic flight control system and, for example, for an altitude of the aircraft, a heading of the aircraft, an indicated air speed of the aircraft, a flight direction vector of the aircraft, and/or the holding of a stationary position. The flight direction vector may be referred to as the “flight path vector” and may be represented by a conformal symbol.

The expression “graphic charter” denotes the way in which the symbol is displayed, for example covering the shape of an object of the symbol and/or the thickness of one or several lines of the symbol and/or the presence or absence of a frame or underlining of an object of the symbol. The symbol representing a current value of a parameter may comprise an object having at least one number, at least one letter, a scale associated with at least one number and/or a cursor, this object being able to be framed or underlined.

This method therefore proposes to display one and the same symbol carrying both the current value of the parameter in question and the status of the operating mode of the automatic flight control system concerning this parameter. When the symbol has a first appearance defined by the first graphic charter, an operator deduces from this that the associated operating mode is the disengaged mode, the automatic flight control system not controlling this parameter. Conversely, when the symbol has a second appearance different from the first appearance and defined by the second graphic charter, an operator deduces from this that the associated operating mode is the engaged mode, the automatic flight control system controlling this parameter.

From a “human” perspective, updating the visual appearance of a symbol, for example by modifying its shape, adding a frame or an underline or indeed thickening a line, is sufficient to update the mental representation that an operator creates in relation to the current operating modes of the automatic flight control system.

The method therefore allows an operator to easily find out, even on a monochromatic head-up display, and in a manner that significantly limits the extent to which part of the outside environment is obscured, what the current operating mode of the automatic flight control system is in relation to one or several parameters. The method does not require the display of a symbol dedicated to the automatic flight control system, such as a conventional automatic flight control information panel, or the display of one or several setpoints per se, in order to know what the current operating mode is.

The method therefore has a limited impact on an operator's field of view by not necessarily adding symbols when the automatic flight control system is active. This simplifies a pilot's workload, for example, by eliminating the pilot's need to consult a head-down display or a head-up display overloaded with information. Flight safety can therefore be increased.

The method may also comprise one or more of the following features.

According to one possibility, for a given current value, the symbol may be in the same position on the head-up display irrespective of the current mode.

A given symbol takes on different appearances when there is a change in the operating mode of the automatic flight control system, but does not move on the head-up display. The disclosure discloses a single symbol that changes appearance, unlike systems that have two independent and unrelated symbols that respectively carry a current value of a parameter and a setpoint.

According to one possibility compatible with the preceding possibilities, said symbol may comprise an object according to the first graphic charter, said symbol comprising said object and a frame at least partially surrounding the object according to the second graphic charter.

Such an object may be in the form of a number, for example, or a scale associated with a cursor and/or a number. The presence of a frame can easily be identified by an operator in order to determine the current operating mode relating to the parameter that is being examined.

According to another possibility, said symbol may comprise a first object according to the first graphic charter, said symbol comprising, according to the second graphic charter, a second object that is visually different from the first object.

The first and second objects may be in the form of a number, for example, a specific geometric shape or a scale associated with a cursor and/or a number. Depending on the object displayed to show the current value of a parameter, an operator can easily deduce the current operating mode relating to this parameter.

For example, the first object may comprise a first geometric shape, the second object comprising a second geometric shape, the second shape being visually different from the first shape.

By way of illustration, a conformal symbol representing a flight direction vector of the aircraft may conventionally comprise a circle and two segments aligned to either side of the circle when the automatic control of the flight direction vector is disengaged. In the engaged mode, the round shape may be replaced by a diamond, for example. An operator can then easily identify whether or not the flight direction vector hold mode is engaged.

Additionally, or alternatively, the first object and the second object may comprise at least one common line, the line being a first thickness in the first object, the line being a second thickness greater than the first thickness in the second object.

According to the example above, a conformal symbol representing a flight direction vector of the aircraft may conventionally comprise a circle and two segments aligned to either side of the circle when the automatic control of the flight direction vector is disengaged. In the engaged mode, the segments may be depicted with thicker lines, the circle or, where appropriate, the diamond that replaces it also being depicted with such thick lines. An operator can then easily identify whether or not the flight direction vector hold mode is engaged.

According to one possibility compatible with the preceding possibilities, said several operating modes may comprise an armed mode wherein said setpoint value is parameterized, provided that the current mode is the armed mode then said method may comprise controlling the head-up display with the control system and displaying said symbol on the head-up display according to a third graphic charter different from the first graphic charter and the second graphic charter.

This means that an operator can tell whether an automatic flight control mode is disengaged, armed or engaged by looking at the symbol carrying the current value of the parameter in question.

According to one possibility compatible with the preceding possibilities, during a change in mode to switch from an old mode to a new mode chosen from said several operating modes, said method may comprise controlling the head-up display with the control system and displaying said symbol on the head-up display, for a predetermined transitional period, alternately according to the graphic charter of the old mode and the graphic charter of the new mode.

This feature helps attract an operator's attention in order to indicate to him or her that the automatic flight control system is changing operating mode for the parameter in question, once again without adding a dedicated symbol.

According to one possibility compatible with the preceding possibilities, the method may comprise detecting that the current value is different from the setpoint value and, provided that the current value is different from the setpoint value, the method may comprise controlling the head-up display with the control system and displaying the setpoint value opposite said symbol on the head-up display.

The setpoint value may be in the immediate vicinity of the associated symbol. A segment may possibly connect the setpoint value and the symbol in order for an operator to immediately make the connection between the setpoint value and the parameter in question.

This feature may also let an operator know whether the setpoint of the automatic flight control system has been reached.

The setpoint value may possibly be arranged, in relation to the eyes of the operator, above the symbol when the setpoint value is greater than the current value and below the symbol when the setpoint value is less than the current value.

This feature also lets an operator know whether the setpoint is greater or less than the current value of the parameter.

A segment possibly extends from the setpoint value to the associated symbol.

A distance separating the setpoint value and the associated symbol possibly varies as a function of a difference between the setpoint value and the current value of the parameter in question. This distance may be obtained using a law giving the distance solely as a function of the abovementioned difference.

Therefore, this setpoint value progressively moves in translation closer to (or further away from) the current value as the aircraft moves closer to (or further away from) said setpoint. If appropriate, the segment shortens (or lengthens) in line with the movement in translation.

Therefore, the positioning of the setpoint value in relation to the associated symbol carries the numerical difference between this setpoint value and the current value carried by this symbol.

Apart from a method, the disclosure relates to an aircraft implementing this method.

Such an aircraft comprises a head-up display and an automatic flight control system, the automatic flight control system comprising a human-machine selection interface for choosing one operating mode from among several predetermined modes comprising a disengaged mode and an engaged mode in order to request the automatic control of at least one parameter, the automatic flight control system being configured, in the engaged mode, to control at least one actuator of the aircraft in order to bring a current value of a controlled parameter towards a setpoint value, said aircraft comprising a control system for controlling said head-up display.

The control system and the head-up display are then configured to apply the method of the disclosure. In particular, the head-up display may be monochromatic.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a diagram showing an aircraft according to the disclosure;

FIG. 2 is a diagram showing a head-down display of the aircraft;

FIG. 3 is a diagram showing the method of the disclosure;

FIG. 4 is a diagram showing a head-up display of an aircraft according to the disclosure in order to illustrate the method of the disclosure; and

FIG. 5 is a diagram showing a head-up display of an aircraft according to the disclosure in order to illustrate the method of the disclosure.

### DETAILED DESCRIPTION

Elements that are present in more than one of the figures are given the same references in each of them.

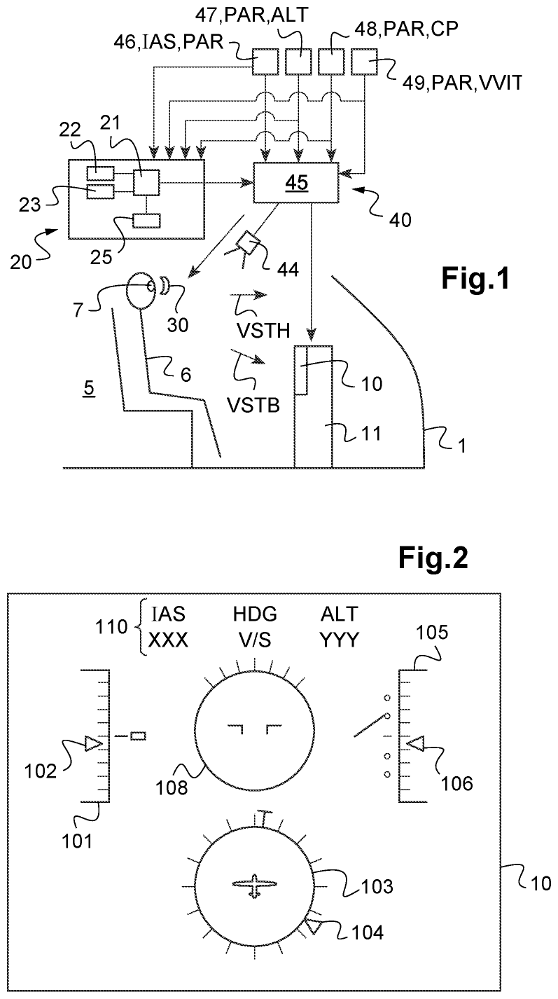

FIG. 1 shows an aircraft 1 of the type of the disclosure, such as an airplane or a rotorcraft. Only components of the aircraft 1 that are directly related to the disclosure are shown so as not to unduly clutter FIG. 1.

This aircraft 1 comprises a cockpit 5 wherein there is at least one operator 6.

This aircraft 1 comprises an automatic flight control system 20. Such an automatic flight control system 20 may also be referred to by the acronym AFCS.

The automatic flight control system 20 comprises at least one actuator 25 used to control the aircraft 1 in order to bring the current value of a parameter PAR towards a setpoint value. For example, on a rotorcraft provided with a rotary wing, an actuator may be extended or retracted or rotated in order to modify the pitch of the blades of the rotary wing. This example is given simply in order to illustrate the disclosure.

The actuator or actuators may be controlled by an automatic flight control computer 21 connected by wired or wireless links to the actuator or actuators 25. By way of example, the automatic flight control computer 21 may comprise at least one processor and at least one memory, at least one integrated circuit, at least one programmable system, or at least one logic circuit, these examples not limiting the scope to be given to the term “computer”. The term “processor” may refer equally to a central processing unit or CPU, a graphics processing unit or GPU, a digital signal processor or DSP, a microcontroller, etc.

Moreover, this automatic flight control system 20 may be provided with a human-machine adjustment interface connected by a wired or wireless link to the automatic flight control computer 21 in order to parameterize the value or values of the setpoint or setpoints.

Furthermore, the automatic flight control system 20 is connected to one or more sensing devices directly or via at least one avionics computer by a connection of a communication network. The sensing device or devices make it possible to estimate the current value or values of the parameter or parameters that can be controlled by the automatic flight control system 20. Each sensing device generates a signal, for example a digital, analog, electrical or optical signal relating to at least one parameter. Each sensing device may comprise a sensor capable of directly measuring the parameter in question but also a system that may comprise one or more physical sensors as well as means for processing the signal that make it possible to provide an estimation of the parameter based on the measurements provided by this or these sensors.

By way of illustration, the aircraft 1 may comprise a speed sensing device 46 for measuring a parameter PAR of the indicated air speed IAS type. Such a speed sensing device 46 may, for example, comprise an anemometer.

The aircraft 1 may comprise an altitude sensing device 47 for measuring a parameter PAR of the altitude ALT type. Such an altitude sensing device 47 may, for example, comprise a radio altimeter.

The aircraft 1 may comprise a heading sensing device 48 for measuring a parameter PAR of the heading CP type. Such a heading sensing device 48 may, for example, comprise a compass.

The aircraft 1 may comprise a flight direction vector sensing device 49 for measuring a parameter PAR of the flight direction vector VVIT type. Such a flight direction vector sensing device 49 may, for example, comprise an inertial unit.

Moreover, the automatic flight control system 20 is provided with a human-machine selection interface 22 that enables the operator 6 to choose, for one or more parameters PAR, an automatic flight control mode referred to more simply as an operating mode. This operating mode may be either a disengaged mode, an engaged mode or an armed mode. When the disengaged mode is activated for a parameter, the automatic flight control system takes no action for this parameter. When the armed mode is activated for a parameter, a setpoint value may be parameterized. When the engaged mode is activated to maintain a parameter PAR, the automatic flight control system 20, and in particular the automatic flight control computer 21, is configured to control at least one actuator 25 in order to bring the value of the parameter PAR, evaluated with the required sensing device or devices, towards a setpoint value.

Moreover, the aircraft 1 is provided with displays to present various items of information to the eyes 7 of the operator 6.

In particular, the aircraft 1 may comprise a head-down display 10 visible to the operator 6 when his or her gaze is directed along a head-down line of vision VSTB. The head-down display 10 is possibly carried by a pedestal or an instrument panel 11. Such a head-down display 10 may comprise a screen and, for example, a multifunction screen known as a “multifunction display” or MFD.

In reference to FIG. 2, such a head-down display 10 may show an image comprising numerous items of information and, for example, a speed indicator 101 showing, if necessary, a speed setpoint 102, a heading rose 103 showing, if necessary, a heading setpoint 104, a pressure altitude indicator 105 showing, if necessary, an altitude setpoint 106, an artificial horizon 108, and an automatic flight control panel 110 showing the engaged automatic flight control modes and the associated setpoint values.

Furthermore, the aircraft 1 comprises a head-up display 30 and a control system 40 for controlling this head-up display 30. The control system 40 is configured to transmit a signal to the head-up display 30, the head-up display 30 displaying one or more symbols after receiving this signal. The head-up display 30 is possibly monochromatic. The head-up display 30 then displays symbols in a single color, usually green.

The head-up display 30 may be fixed, for example being of the HUD type, or may be worn. The head-up display 30 may be of a conventional type and, for example, may be a system referred to as a “head-mounted display”, a system referred to as a “head-worn display”, a system referred to as a “near-eye display”, a system referred to as a “helmet-mounted display” when mounted on a helmet, or indeed, for example, a “helmet-mounted sight and display”.

The head-up display 30, and indeed the head-down display 10, can be controlled by a computer referred to for the sake of convenience as a “display computer 45”. A display computer 45 is thus connected to the head-up display 30 and the head-down display 10 by a wired or wireless connection. The display computer 45 and the automatic flight control computer 21 may possibly form one and the same computer.

The display computer 45 may comprise one or more symbol generator computers. For example, the display computer 45 may comprise a head-up symbol generator computer and a head-down symbol generator computer. According to another example, the display computer 45 may comprise a single symbol generator computer. Each symbol generator computer may, for example, comprise at least one processor and at least one memory, at least one integrated circuit, at least one programmable system, or at least one logic circuit, these examples not limiting the scope to be given to the term “symbol generator computer”. The term “processor” may refer equally to a central processing unit or CPU, a graphics processing unit or GPU, a digital signal processor or DSP, a microcontroller, etc.

The display computer 45 may be directly or indirectly connected to the various sensing devices of the aircraft 1 and, in particular, to the abovementioned sensing devices 46-49.

Moreover, the display computer 45 may be connected to a positioning device 44 determining information relating to the position and indeed the orientation of the head-up display 30, in the case of a worn head-up display 30.

The positioning device 44 is connected to the display computer 45 by a wired or wireless link in order to transmit a signal to it, for example an analog or digital signal. This signal enables the display computer 45 to determine, using a known technique, where to position certain symbols. According to the example shown, the positioning device 44 thus comprises at least one camera.

The examples provided are given by way of illustration. Indeed, the control system 40 and the automatic flight control system 20 may be of another known type without going beyond the ambit of the claims.

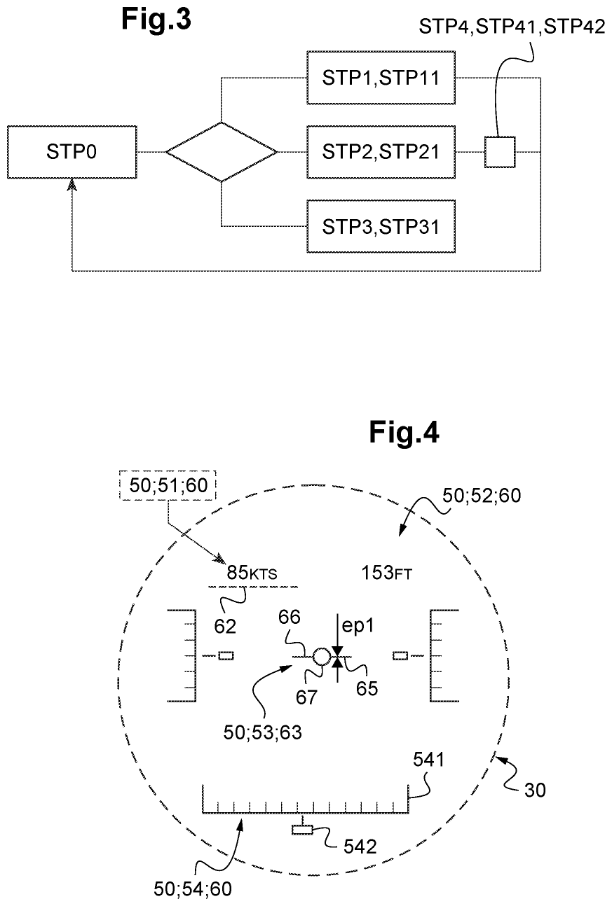

Irrespective of the embodiment of the head-up display 30 and the control system 40 and the automatic flight control system 20, the control system 40 and the head-up display 30 are configured to apply the method shown schematically in FIG. 3. This method comprises one or more of the following steps carried out in a loop.

This method comprises, for at least one parameter PAR, detecting, STP0, with a control system 40, a current mode applied by the automatic flight control system 20. The current mode is chosen by an operator 6 from among the predetermined operating modes of the automatic flight control system 20. For example, the human-machine selection interface 22 transmits a signal carrying the current mode to be applied to the control system 40, and possibly to the display computer 45, directly or via the automatic flight control computer 21.

The method then comprises controlling STP1, STP2, STP3 the head-up display 30 with the control system 40 and, in particular, with the display computer 45. The control system 40 then transmits a control signal to the head-up display 30 that varies as a function of the applied current mode for each parameter PAR. The control signal may comprise the symbols to be displayed. Following receipt of the control signal, the method comprises, for each parameter PAR, displaying STP11, STP21 STP31 a symbol 50 on the head-up display 30 carrying the current value of the parameter PAR according to a graphic charter specific to the current mode.

Therefore, when the operating mode of the automatic flight control system 20 is the disengaged mode for a parameter PAR, the display computer 45 controls STP1 the head-up display 30 by transmitting a control signal to it. Following receipt of this control signal, the head-up display 30 displays STP11 a symbol carrying the current value of this parameter PAR according to a first graphic charter. The first graphic charter defines the appearance to be given to this symbol.

This symbol may comprise an object. This object may be a number equal to the current value, a scale and a cursor pointing to a value on the scale equal to the current value, for example, or a geometric shape. The graphic charter may then define, for example, the thickness of at least one line of an object, the addition or non-addition of a frame at least partially surrounding the object, the shape to be given to the object, etc.

When the operating mode of the automatic flight control system 20 is the engaged mode for a parameter PAR, the display computer 45 controls STP2 the head-up display 30 by transmitting a control signal to it. Following receipt of this control signal, the head-up display 30 displays STP21 a symbol carrying the current value of this parameter PAR according to a second graphic charter. The appearance of the symbol is different with the second graphic charter from the appearance obtained with the first graphic charter for the same value of the parameter PAR.

When the operating mode of the automatic flight control system 20 is the armed mode for a parameter PAR, the display computer 45 controls STP32 the head-up display 30 by transmitting a control signal to it. Following receipt of this control signal, the head-up display 30 displays STP31 a symbol carrying the current value of this parameter PAR according to a third graphic charter. The third graphic charter defines the appearance to be given to this symbol, the appearance of the symbol being different from the appearance obtained with the first graphic charter and the second graphic charter for the same value of the parameter PAR.

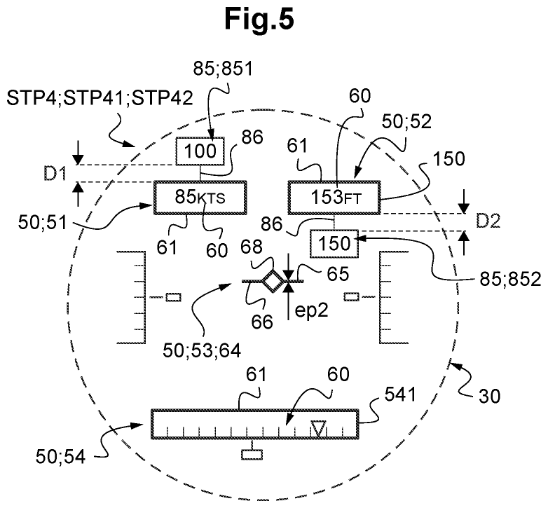

FIGS. 4 and 5 show the method of the disclosure with examples.

FIG. 4 shows the display of symbols 50 associated with parameters PAR for which the automatic flight control system 20 is not engaged. FIG. 5 shows the display of symbols 50 associated with these same parameters PAR but for which the automatic flight control system 20 is engaged. Reference number 50 denotes any symbol, reference numbers 51 to 54 denoting particular symbols.

According to the example shown in FIG. 4, the head-up display 30 may show a symbol 51 carrying the current value of the indicated air speed measured with the speed sensing device 46, a symbol 52 carrying the current value of the altitude measured with the altitude sensing device 47, a symbol 54 carrying the current heading value measured with the heading sensing device 48 and a symbol 53 carrying the current flight direction vector displayed conformally and measured with the flight direction vector sensing device 49.

According to a first variant, a symbol 50 may comprise an object 60 according to the first graphic charter, and this same object 60 and a frame 61 at least partially surrounding it according to the second graphic charter.

According to FIG. 4, this object 60 may comprise a number equal to the current value of the associated parameter PAR, and indeed letters forming the unit used, as shown on the symbol 51, that carries the current value of the indicated air speed, and on the symbol 52, that carries the current altitude value. An object 60 may alternatively comprise a scale 541 and a pointer 542, as shown by the symbol 54, that carries the current heading value.

The object 60 may possibly be underlined when the third graphic charter is being applied, in order to indicate that the automatic flight control mode associated with the associated parameter PAR is the armed mode. The symbol 51 carrying the current indicated air speed value thus comprises a dashed line under the corresponding object in order to illustrate this possibility.

In reference to FIG. 5, when the automatic flight control system is engaged to control the abovementioned parameters PAR, a symbol 50 comprises a frame 61 that at least partially surrounds the object 60. Therefore, the symbol 51 and the symbol 52 both comprise an object 60 that is completely surrounded by a rectangular frame 61 in the example shown, whereas the symbol 54 comprises a frame 61 that partially surrounds its object. The frame 61 may however be in any other shape, for example a hexagonal shape.

According to a second variant, and in reference to FIG. 4, said symbol 53 may comprise a first object 63 according to the first graphic charter. Therefore, the symbol 53 carrying the flight direction vector comprises a first geometric shape comprising two segments 65, 66 that lie to either side of a circle 67, the two segments 65, 66 being aligned.

However, as shown in FIG. 5, this same symbol 53 may, according to the second graphic charter, comprise a second object 64 visually different from the first object 63.

For example, the first object 63 comprises a first geometric shape, and the second object 64 comprises a second geometric shape that is different. Therefore, the symbol 53 carrying the flight direction vector now comprises a second geometric shape comprising two segments 65, 66 that lie to either side not of a circle 67 but of a diamond 68, the two segments 65, 66 being aligned.

For example, the first object 63 and the second object 64 may comprise at least one common line. Therefore, the first object 63 and the second object 64 both comprise the segments 65, 66 according to the example of the symbol 53. However, the lines 65, 66 have a first thickness ep1 in the first object 63 shown in FIG. 4 and a second thickness ep2 greater than the first thickness ep1 in the second object 64 shown in FIG. 5.

Regardless of the variant, the graphic charter that is applied does not affect the position of the symbol 50 on the head-up display 30. For a given current value of a parameter PAR, the associated symbol 50 is in the same position, i.e., in the same restricted area of the head-up display 30, irrespective of which graphic charter is applied.

Moreover, during a transitional phase for switching from an old mode to a new mode chosen from said possible operating modes of the automatic flight control system 20, for example to indicate a switch from the disengaged mode to the engaged mode, the control system 40 may control the head-up display 30 to display the symbol 50 in question on the head-up display 30 for a predetermined transitional time period, alternately according to the graphic charter of the old mode and the graphic charter of the new mode.

According to another aspect of the disclosure and in reference to FIG. 5, the control system 40 may be configured to detect STP4 that the current value of a parameter is different from its setpoint value transmitted by the automatic flight control system 20. In this case, the method of the disclosure may comprise a command STP41 transmitted from the control system 40 to the head-up display 30 to request the display STP42 of the setpoint value 85 opposite the symbol 50 in question on the head-up display 30. A segment 86 may possibly extend from the setpoint value to the symbol 50. The setpoint value is possibly arranged, in relation to the eyes 7 of the operator 6, above the symbol 50 when the setpoint value 85 is greater than the current value, and below the symbol 50 when the setpoint value 85 is less than the current value. According to the example shown, a setpoint value 851 of the indicated air speed is thus arranged above the symbol 51 and a setpoint value 852 of the altitude is arranged below the symbol 52.

A distance D1, D2 separating the setpoint value and the associated symbol possibly varies as a function of the result of a subtraction between the setpoint value and the current value of the parameter in question. The same applies to the length of the segment that is possibly displayed.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for assisting the piloting of an aircraft comprising a head-up display and an automatic flight control system, the automatic flight control system comprising a human-machine selection interface for choosing an operating mode from among several predetermined operating modes comprising a disengaged mode and an engaged mode in order to request the automatic control of at least one parameter, the automatic flight control system being configured, in the engaged mode, to control at least one actuator of the aircraft in order to bring a current value of the parameter towards a setpoint value, the method comprising the following steps:
detecting, with a control system, an applied current mode from among the several predetermined operating modes; and
controlling the head-up display with the control system, and displaying a symbol carrying the current value on the head-up display,
wherein the displaying of a symbol carrying the current value on the head-up display is carried out according to a graphic charter specific to the current mode in order to display the current mode, a first graphic charter applied during the disengaged mode being different from a second graphic charter applied during the engaged mode.

2. The method according to claim 1,
wherein, for a given current value, the symbol is in the same position on the head-up display, irrespective of the current mode.

3. The method according to claim 1,
wherein the symbol comprises an object according to the first graphic charter, the symbol comprising the object and a frame at least partially surrounding the object according to the second graphic charter.

4. The method according to claim 1,
wherein the symbol comprises a first object according to the first graphic charter, the symbol comprising, according to the second graphic charter, a second object that is visually different from the first object.

5. The method according to claim 4,
wherein the first object comprises a first geometric shape, the second object comprising a second geometric shape, the second shape being visually different from the first shape.

6. The method according to claim 4,
wherein the first object and the second object comprise at least one common line, the line being a first thickness in the first object, the line being a second thickness greater than the first thickness in the second object.

7. The method according to claim 1,
wherein the several operating modes comprise an armed mode wherein the setpoint value is parameterized, provided that the current mode is the armed mode then the method comprises controlling the head-up display with the control system and displaying the symbol on the head-up display according to a third graphic charter different from the first graphic charter and the second graphic charter.

8. The method according to claim 1,
wherein, during a change in mode to switch from an old mode to a new mode chosen from the several operating modes, the method comprises controlling the head-up display with the control system and displaying the symbol on the head-up display, for a predetermined transitional period, alternately according to the graphic charter of the old mode and the graphic charter of the new mode.

9. The method according to claim 1,
wherein the method comprises detecting that the current value is different from the setpoint value and, provided that the current value is different from the setpoint value, the method comprises controlling the head-up display with the control system and displaying the setpoint value opposite the symbol on the head-up display.

10. The method according to claim 9,
wherein the setpoint value is arranged, in relation to the eyes of the operator, above the symbol when the setpoint value is greater than the current value, and below the symbol when the setpoint value is less than the current value.

11. The method according to claim 9,
wherein a distance separating the setpoint value and the associated symbol varies as a function of a difference between the setpoint value and the current value of the parameter in question.

12. An aircraft comprising a head-up display and an automatic flight control system, the automatic flight control system comprising a human-machine selection interface for choosing an operating mode from among several predetermined modes comprising a disengaged mode and an engaged mode in order to request the automatic control of at least one parameter, the automatic flight control system being configured, in the engaged mode, to control at least one actuator of the aircraft in order to bring a current value of the controlled parameter towards a setpoint value, the aircraft comprising a control system for controlling the head-up display,
wherein the control system and the head-up display are configured to apply the method according to claim 1.

13. The aircraft according to claim 11,
wherein the head-up display is monochromatic.
